(19) United States
(12) Patent Application Publication
(10) Pub. No.: US 2019/0228400 A1
(43) Pub. Date: Jul. 25, 2019

(54) FUELING METHOD USING WIRELESS COMMUNICATION

(71) Applicant: Kyoung-Su PARK, Hwaseong-si (KR)

(72) Inventor: Kyoung-Su PARK, Hwaseong-si (KR)

(21) Appl. No.: 16/371,777

(22) Filed: Apr. 1, 2019

Related U.S. Application Data
(63) Continuation-in-part of application No. 14/414,908, filed on Jan. 15, 2015, now abandoned.

(30) Foreign Application Priority Data
Jul. 16, 2012 (KR) 20-2012-0006278
Aug. 26, 2012 (KR) 10-2012-0093360
Nov. 28, 2012 (KR) 10-2012-0135932

(51) Int. Cl. G06Q 20/32; G06Q 20/40; G07F 15/00; G06Q 50/06

(52) U.S. Cl. CPC G06Q 20/325; G06Q 20/40145; G06Q 50/06; G06Q 20/3278; G07F 15/001; G06Q 20/3224

(57) ABSTRACT

A fueling method using wireless communication capable of mis-fueling is disclosed. The fueling method is performed in a fueling system comprising: a communication module in communication with a mobile device; a gas pump supplying a fuel to a vehicle; a display/input device receiving user input and displaying a screen; and a controller controlling the communication module and the gas pump, and comprises: (a) receiving fueling information containing at least one of fuel type information, purchase amount information, payment information and gas pump information from mobile device by controlling the communication module; (b) acquiring missing information missing from the fueling information when one or more of the fuel type information, the purchase amount information, the payment information and the gas pump information is missing from the fueling information; (c) making a payment according to the payment information included in the fueling information received in (a) or the payment information included in the missing information acquired in (b); and (d) setting the gas pump for fueling based on the fueling information received in (a) or the missing information acquired in (b).

### CROSS-REFERENCE TO RELATED PATENT APPLICATION

This application is a continuation-in-part of U.S. application Ser. No. 14/414,908 filed Jan. 15, 2015, which is a national stage of International Application No. PCT/KR2013/006304 filed on Jul. 15, 2013, which claims the benefit of Korean Patent Application No. 20-2012-0006278 filed Jul. 16, 2012, Korean Patent Application No. 10-2012-0093360 filed Aug. 26, 2012 and Korean Patent Application No. 10-2012-0135932 filed Nov. 28, 2012 in the Korean Intellectual Property Office. All disclosures of the documents named above are incorporated herein by reference.

### BACKGROUND OF THE INVENTION

### 1. Field

The present invention relates to a fueling method using wireless communication.

### 2. Description of the Related Art

When fueling a vehicle at the gas station, the amount and the type of fuel are selected. However, when the type of fuel is selected by operating the gas pump of the gas station, it is possible to select wrong amount or wrong fuel type. In particular, wrong fuel type is very likely to damage to the vehicle. Therefore, a fueling method capable of preventing such mistake is necessary.

### SUMMARY OF THE INVENTION

Described herein is a fueling method using wireless communication capable of mis-fueling in gas station.

According to one aspect of the invention, there is provided a fueling method performed in a fueling system comprising: a communication module in communication with a mobile device; a gas pump supplying a fuel to a vehicle; a display/input device receiving user input and displaying a screen; and a controller controlling the communication module and the gas pump, the method comprising: (a) receiving fueling information containing at least one of fuel type information, purchase amount information, payment information and gas pump information from mobile device by controlling the communication module; (b) acquiring missing information missing from the fueling information when one or more of the fuel type information, the purchase amount information, the payment information and the gas pump information is missing from the fueling information; (c) making a payment according to the payment information included in the fueling information received in (a) or the payment information included in the missing information acquired in (b); and (d) setting the gas pump for fueling based on the fueling information received in (a) or the missing information acquired in (b).

Preferably, the fueling method further comprises: (e) requesting a modification of the fueling information via the display/input device when the mobile device approaches the fueling system.

Preferably, (d) comprises: setting the gas pump for fueling based on the fueling information modified in (e) when the modification of the fueling information is received via the display/input device.

Preferably, the communication module comprises a near field communication module, and (a) comprises: receiving the fueling information from the mobile device by controlling the near field communication module.

Preferably, the communication module comprises a barcode reader, and (a) comprises: receiving the fueling information in barcode or QR code from the mobile device by controlling the barcode reader.

Preferably, the fueling method further comprises: (f) receiving at least one of coupon information and mileage information by controlling the communication module.

Preferably, the communication module comprises a near field communication module, and (f) comprises: receiving at least one of the coupon information and the mileage information from the mobile device by controlling near field communication module.

Preferably, the communication module comprises a network module, and (a) comprises: receiving the fueling information from the mobile device by controlling the network module.

Preferably, the communication module further comprises a near field communication module further comprises: receiving at least one of coupon information and mileage information from the mobile device by controlling near field communication module.

Preferably, (b) comprises: (b-1) requesting the missing information when the missing information exists in the fueling information; and (b-2) receiving the missing information via the display/input device.

Preferably, the fueling method further comprises: (h) receiving identification code of the mobile device by controlling the communication module.

Preferably, (b) comprises: acquiring the payment information from the identification code received in (h) when the payment information is missing from the fueling information.

Preferably, (c) comprises: (c-1) authenticating the payment information acquired in (b); and making a payment when the payment information is authenticated in (c-1).

Preferably, (c-1) comprises authenticating the payment information by at least one of fingerprint, password and iris recognition.

Preferably, the fueling method further comprises: (i) acknowledging the mobile device via the communication module when the mobile device approaches the fueling system.

Preferably, (i) comprises acknowledging the mobile device based on position information transmitted from the mobile device and received via the communication module when the mobile device approaches the fueling system.

### BRIEF DESCRIPTION OF THE DRAWINGS

FIG. 1 is a block diagram schematically illustrating a fueling system and a mobile device wherein a fueling method according to a first embodiment of the present invention is performed.

FIG. 2 is a block diagram schematically illustrating a fueling system and a mobile device wherein a fueling method according to a second embodiment of the present invention is performed.

FIG. 3 is a flow chart illustrating a fueling method according to the first embodiment of the present invention.

FIGS. 4A through 4C illustrates screens displayed on the mobile device used in the fueling method according to the first embodiment of the present invention is performed.

FIG. 5 is a flowchart illustrating a step S500 of the fueling method according to the first embodiment of the present invention.

FIG. 6 is a flowchart illustrating steps S810 and S820 of the fueling method according to the first embodiment of the present invention.

FIGS. 7A through 7D illustrates screens displayed on the mobile device used in the fueling method according to the second embodiment of the present invention is performed.

FIG. 8 illustrates an input screen of the fueling system for inputting an identification code according to the second embodiment of the present invention.

FIG. 9 is a flow chart illustrating the fueling method according to the second embodiment of the present invention.

### DETAILED DESCRIPTION OF THE INVENTION

Hereinafter, a fueling system in which a fueling method according to a first embodiment of the present invention is performed will be described in detail with reference to the accompanying drawings.

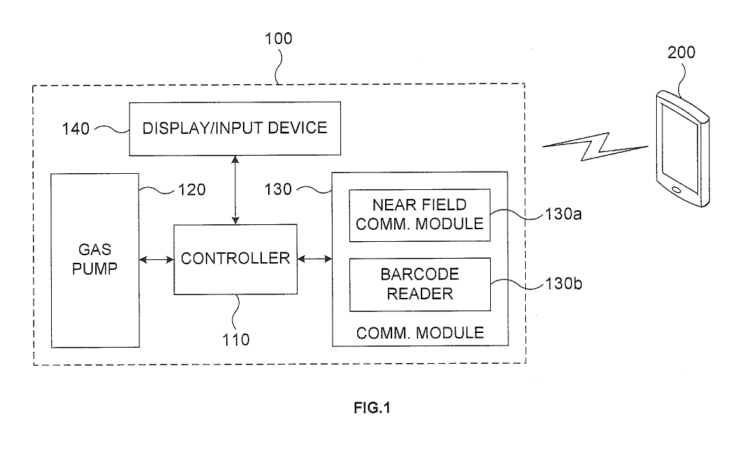

FIG. 1 is a block diagram schematically illustrating the fueling system and the mobile device wherein the fueling method according to the first embodiment of the present invention is performed.

Referring to FIG. 1, a fueling system 100, wherein the fueling method according to the first embodiment of the present invention is performed, includes a controller 110, a gas pump 120, a communication module 130, and a display/input device 140.

The communication module 130 may include a near field communication module 130a to wirelessly communicate with a mobile device 200. As shown in FIG. 1, the communication module 130 may communicate with the mobile device 200 via the near field communication module 130a according to near field communication protocol. Here, the near field communication module 130a may conform to the NFC standard defined by ISO/IEC 18092, etc. In addition, the communication module 130 may also include a barcode reader 130b to wirelessly communicate with the mobile device 200 by reading a barcode (e.g., a conventional barcode, QR code) displayed on the screen of the mobile device 200 such as a smart phone. In addition, the communication module 130 may include an IC card reader (not shown), a magnetic strip reader (not shown), and the like.

The communication module 130 may be provided in or on the gas pump 120. For example, the near field communication module 130a and the barcode reader 130b may be provide on, but not limited to, the outer surface of the gas pump 120 to facilitate communication with the mobile device 200.

The display/input device 140 displays various information (e.g., fuel type, amount of supplied fuel, etc.) and receives user input from a user. For example, the display/input device 140 may be a touch screed device comprising a liquid crystal display and a touch panel. The information and data inputted via the display/input device 140 may be transmitted to the controller 110. In addition, the display/input device 140 may display various screens under the control of the controller 110.

The display/input device 140 may be installed at the gas pump 120 to display information necessary for the user of the gas pump, and may be configured to receive information inputted by the user of the gas pump to be transmitted to the controller 110. In addition, the display/input device 140 may be provided at the cashier counter to display information necessary for an operator, and may be configured to receive the information inputted by the operator to be transmitted to the controller 110. That is, one or more display/input devices 140 may be provided, and the number thereof and the installation location thereof are not limited.

The gas pump 120 where the fuel is stored is connected to a fuel tank (not shown), and supplies selected fuel to the vehicle under the control of the controller 110. One or more gas pumps 120 may be provided.

The controller 110 controls the communication module 130 and the gas pump 120. Specifically, the controller 110 includes a processor (not shown), a memory (not shown) and a storage device (not shown). The controller 110 may also control the communication module 130 to receive data (e.g., fueling information) from the mobile device 200 or to transmit data to the mobile device 200. The controller 110 sets the type and the amount of fuel to be supplied according to the received data and controls the gas pump 120 to supply the fuel to the vehicle according to the type and the amount of fuel. When there are two or more gas pumps 120, the controller 110 may independently control two or more gas pumps 120. For example, when a specific gas pump is designated in the fueling information, the controller 110 may control the corresponding gas pump 120 according to the fueling information. In addition, when the display/input device 140 is provided at the gas pump 120, the controller 110 may acknowledge the corresponding gas pump 120 to be controlled by receiving information from the display/input device 140 of the corresponding gas pump 120.

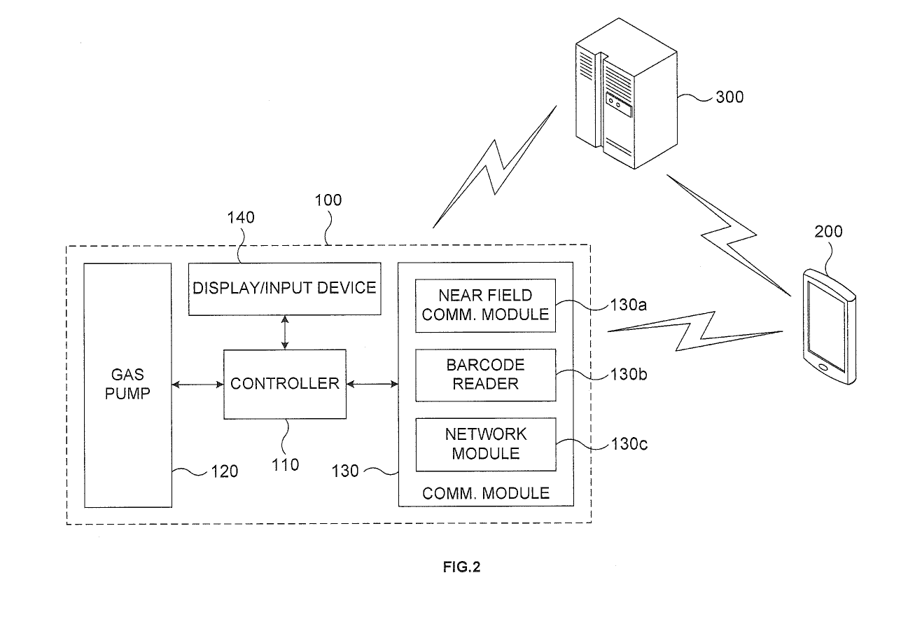

FIG. 2 is a block diagram schematically illustrating a fueling system and a mobile device wherein a fueling method according to a second embodiment of the present invention is performed.

The fueling system 100 shown in FIG. 2 is substantially the same as the fueling system 100 shown in FIG. 1 except for a network module 130c. Therefore, only the network module 130c will be described in detail below.

The network module 130c communicates with a server 300 which is interlinked with the mobile device 200 via a network such as the Internet. The network module 130c may also communicate with the mobile device 200 via the network and the server 300. That is, the network module 130c may receive data from the server 300 and the mobile device 200 through the network, or may transmit data to the server 300 and the mobile device 200. The network module 130c may communicate via the Internet wireless manner (WIFI) or in wired manner (Ethernet).

Coupon information, mileage information, and the like are stored in the server 300, and the coupon information, the mileage information, and the like stored therein may be retrieved by the fueling system 100 and the mobile device 200 at the user's request.

Hereinafter, a fueling method according to the first embodiment of the present invention will be described in detail with reference to the accompanying drawings.

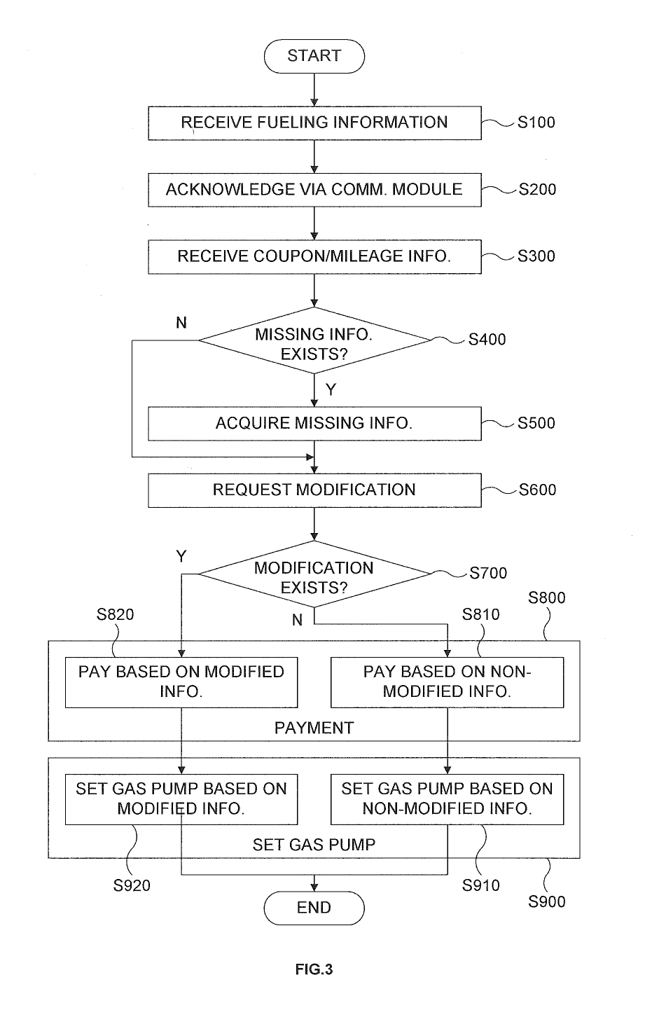

FIG. 3 is a flow chart illustrating a fueling method according to the first embodiment of the present invention.

Referring to FIG. 3, the controller of the fueling system controls the communication module to communicate with the mobile device and receive fueling information from the mobile device (step S100).

Here, the fueling information includes information on at least one of fuel type (hereinafter referred to as “fuel type information”), purchase amount (hereinafter referred to as “purchase amount information”), payment (hereinafter referred to as “payment information”) and gas pump (hereinafter referred to as “gas pump information”). According to an example, the fueling information may include the fuel type information and the purchase amount information. According to another example, the fueling information may include the fuel type information, the purchase amount information, the payment information and the gas pump information. That is, the fueling information may collectively refer to a group of information including at least one of the fuel type information, the purchase amount information, payment information and gas pump information.

Here, the fuel type information refers to the type of fuel such as gasoline and diesel, the purchase amount information refers to an amount of fuel to be purchased in dollars or in gallons, payment information refers to payment method (cash, credit card, etc.), and the gas pump information refers to the gas pump number of a particular gas station. In particular, when the payment method is a credit card, the payment information may include information about a credit card such as a credit card number. Credit card numbers etc. may be stored in the SIM card of the mobile device.

When the communication module includes the near field communication module, the fueling system may control the near field communication module to receive fueling information from the mobile device. In addition, when the communication module includes the barcode reader, the fueling system may control the barcode reader to receive fueling information from the mobile device.

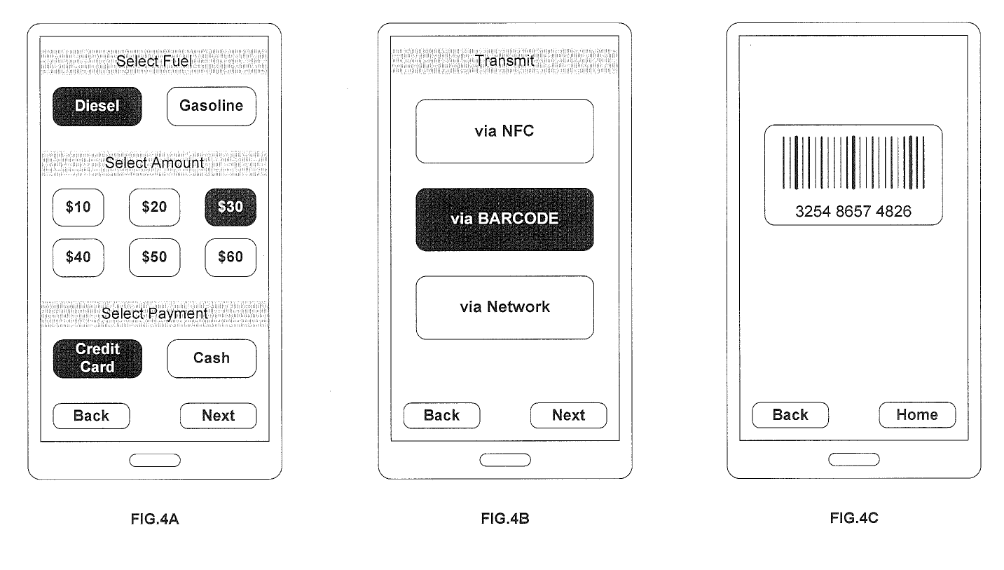

Hereinafter, a method of generating the fueling information in the mobile device will be described in detail with reference to FIGS. 4A through 4B.

FIGS. 4A through 4C illustrates screens displayed on the mobile device used in the fueling method according to the first embodiment of the present invention is performed.

Referring to FIG. 4A, a screen for selecting the type of fuel, the amount to be purchased, and payment method is displayed on a display of the mobile device. The user may select the fuel type corresponding to the fuel type information of the fueling information, the purchase amount corresponding to the purchase amount information of the fueling information, and the payment method corresponding to the payment information of the fueling information from the screen shown in FIG. 4A. The screen shown in FIG. 4A exemplifies that the user has selected diesel as the fuel type, $30 as the amount to be purchased and a credit card as the payment method. However, the screen may further display buttons for selecting a gas station and a gas pump number corresponding to gas pump information of fueling information. In addition, when credit card is selected as the payment method, a screen for inputting credit card number may be displayed. Further, the mobile device may display buttons for selecting the amount of fuel to be purchased in gallons (e.g. 10 gallons, 20 gallons) as the purchase amount information of the fueling information instead of the buttons for selecting the amount in dollars. The fueling information is then generated based on the selection of the user from the screen shown in FIG. 4A and then stored in the mobile device.

When the user presses “Next” button shown in FIG. 4A, the screen shown in FIG. 4B is then displayed.

Referring to FIG. 4B, a screen for selecting a method for communicating with the fueling system is displayed on the display of the mobile device. The user may select the communication method from the screen shown in FIG. 4B. A screen wherein a barcode is selected as the communication method is exemplified in FIG. 4B.

When the user presses “Next” button shown in FIG. 4B, the screen shown in FIG. 4C is then displayed.

Referring to FIG. 4C, a barcode corresponding to the fueling information which is generated based on the selection by the user is displayed on the display of the mobile device. When the barcode reader of the fueling system reads the barcode, the fueling information is transmitted to the fueling system.

When the user selects NFC from the screen shown in FIG. 4B, the mobile device may display a screen requesting the mobile device to be placed in proximity of the near field communication module of the fueling system. When the user selects “Network” from the screen shown in FIG. 4B, a screen showing the transmission status of fueling information may be displayed on the display of the mobile device. At this time, the fueling information may be transmitted from the mobile device to the fueling system through the mobile network.

Referring back to FIG. 3, the fueling system acknowledges whether the mobile device is in proximity of the fueling system via the communication module (step S200). That is, the fueling system checks whether the mobile device is in close distance (within a fueling zone) via the communication module.

For example, as the mobile device transmits position information (or vehicle) detected by GPS (Global Positioning System) of the mobile device to the server, the fueling system controls the network module to receive the position information of the mobile device from the server. The fueling system compares the received position information of the mobile device with the position information of the fueling system to determine whether the mobile device is approaching the fueling system. Whether the mobile device in vicinity of the fueling system may be determined in the step S300 without using NFC and barcode. To receive the fueling information via NFC or barcode, the mobile device should be brought into contact with or be in proximity to the fueling system. Thus, receiving the fueling information via NFC or barcode means that the mobile device has approached the fueling system sufficiently. On the other hand, when the mobile device transmits the fueling information to the fueling system through the network, whether the mobile device in sufficient proximity of the fueling system may be determined based on the position information of the mobile device.

In order to supply fuel to a vehicle, the vehicle should be in proximity of the gas pump of the fueling system. This can be determined based on the position information of the mobile device which also represents the position information of the vehicle.

While the position information of the mobile device (or vehicle) may be acquired through GPS, the way of obtaining the position information of the mobile device is not limited thereto. For example, the position information of the mobile device may be acquired using the location of the cell tower to which the mobile device is connected.

When the vehicle is equipped with a dedicated device that transmits the vehicle's position information to the fueling system, whether the mobile device in proximity of the fueling system may be determined by the position information transmitted by the dedicated device.

In addition, when the fueling information is received through NFC or barcode, step S300 may be omitted since receiving the fueling information through NFC or barcode means that the vehicle or the mobile device is already in proximity of the fueling system.

Referring to FIG. 3, the fueling system may control the communication module to receive at least one of discount coupon information and mileage information from a mobile device or a server (step S300).

The process of receiving discount coupon information and mileage information is as follows.

For example, the controller of the fueling system may control the near field communication module of the communication module to receive the discount coupon information and the mileage information from the mobile device via a near field communication protocol. In addition, the controller of the fueling system may control the barcode reader to receive the discount coupon information and the mileage information displayed on the screen of the mobile device as barcodes.

In another example, the fueling system may control the network module to receive the discount coupon information and the mileage information stored in the server through the network upon request of the mobile device.

When the discount coupon information and the mileage information are not available, step S300 may be omitted.

Thereafter, the fueling system checks whether there is missing information in the received fueling information (step S400).

In order to fuel the vehicle, the user should at least select the fuel type, the purchase amount and the payment method. As described above, the fueling information includes information on the fuel type and the like. However, the fueling information may not contain all the necessary information for fueling. For example, in case the user does not select payment method on the screen shown in FIG. 4A, the received fueling information includes only the fuel type information and the purchase amount information, and the payment information is missing from the fueling information. Hereinafter, one or more of the fuel type information, the purchase amount information, the payment information and the gas pump information that are not contained in the fueling information is collectively referred to as “missing information.”

When there is missing information in the received fueling information (Y in step S400), the missing information is acquired (step S500).

Hereinafter, the step S500 will be described in detail with reference to FIG. 5

FIG. 5 is a flowchart illustrating the step S500 of the fueling method according to the first embodiment of the present invention.

Referring to FIG. 5, when missing information exists, the fueling system requests the missing information via the display/input device (step S500a). For example, when the payment information is not included in the received fueling information, the fueling system may display a screen requesting credit card information on the display/input device provided at the gas pump or at the cashier counter. In another example, when the gas pump information is not included in the received fueling information, the fueling system may display a screen requesting the gas pump number on the display/input device provided at the gas pump or at the cashier counter.

Thereafter, the fueling system receives the missing information via the display/input device (step S500b). For example, the fueling system may receive credit card information via the display/input device or a credit card reader installed at the gas pump or at the cashier counter. In another example, the fueling system may receive a gas pump number via the display/input device installed at the gas pump or at the cashier counter.

When there is no missing information in the received fueling information (N in step S400) or when the missing information is acquired by performing step S500, step S600 is performed.

Thereafter, when the mobile device is in proximity of the fueling system, the fueling system requests the modification of the fueling information via the display/input device (step S600). For example, the fueling system may display a screen showing the fuel type information, the purchase amount information and the payment information included in the received fueling information on the display/input device, and inquires whether any information is to be modified. When the fueling information is modified by the user via the display/input device (Y in step S700), i.e., when the modification of the fueling information is received via the display/input device, the step S820 is performed. When the fueling information is not modified (N in step S700), the step S810 is performed. Hereinafter, steps S810 and S820 are collectively referred to as step S800.

Thereafter, the purchase amount is paid based on the payment information (step S800).

The step S800 includes a payment step S810 when the fueling information has not been modified and a payment step S820 when the fueling information has been modified. The steps S810 and S820 will be described below in detail.

First, when the fueling information has not been modified, the fueling system makes payment in the purchase amount based on the fueling information received in step S100 or the payment information included in the missing information acquired in step S500 (step S810). For example, when the fueling information received in step S100 includes the payment information and the purchase amount information, the fueling system settles the purchase amount according to the payment information and the purchase amount information. When the payment information and/or the purchase amount information are not included in the fueling information received in step S100, the fueling system settles the purchase amount acquired in step S500, That is, the fueling system settles the purchase amount according to the payment information and the purchase amount information acquired in step S500.

When the fueling information has been modified, the fueling system settles the purchase amount based on: the payment information included the fueling information received in step S100; the payment information included the fueling information received in step S100 and modified in the step S600; the payment information included in the missing information acquired in step S500; or the payment information included in the missing information acquired in step S500 and modified in the step S600 (step S820). For example, when information other than the payment information and the purchase amount information is modified in step S600, the fueling system may settle (charge) the purchase amount based on the payment information included in the fueling information received in step S100 or the payment information included in the missing information acquired in step S500. In another example, when at least one of the payment information and the purchase amount information is modified in step S600, the fueling system may settle the modified purchase amount and/or the purchase amount information.

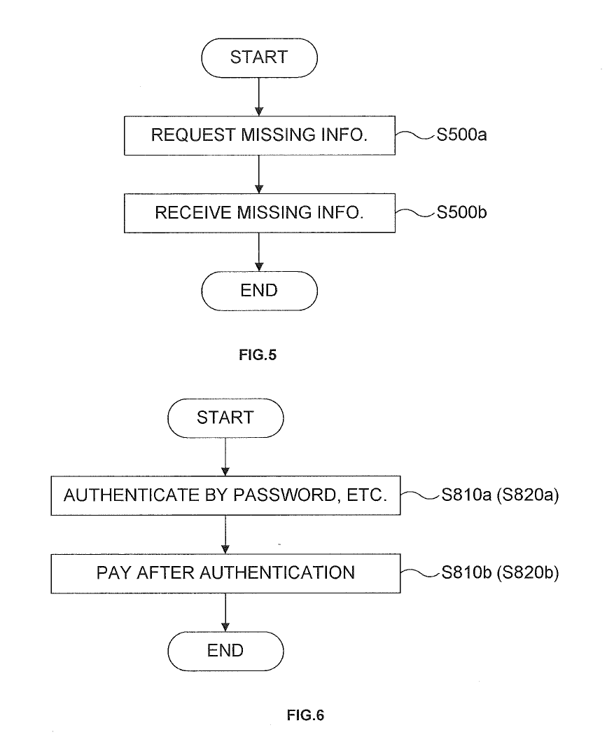

The steps S810 and S820 will be described below in detail with reference to FIG. 6. Since the steps S810 and S820 are the same except the information on which the payment is based, the steps S810 and S820 will be collectively described hereinafter.

FIG. 6 is a flowchart illustrating the steps S810 and S820 of the fueling method according to the first embodiment of the present invention.

Referring to FIG. 6, the step S810 includes a step S810a of authenticating the payment information and a step S810b of settling the purchase amount according to the payment information having the authentication thereof completed.

Similarly, the step S820 includes a step S820a for authenticating the payment information and a step S820b for settling the purchase amount according to the payment information having the authentication thereof completed.

Here, the authentication may be performed via fingerprint, password or iris recognition.

Referring back to FIG. 3, when the settlement is completed, the gas pump is set (step S900).

The step S900 includes a gas pump setting step S910 when the fueling information has not been modified and a gas pump setting step S920 when the fueling information has been modified. The steps S910 and S920 will be described in detail.

When the fueling information has not been modified, the controller of the fueling system sets the gas pump according to the fuel type information and the purchase amount information included in the fueling information received in step S100 (step S910). In one example, when the fuel type information and/or amount information are included in the missing information acquired in step S500, the controller of the fueling system sets the gas pump according to the fuel type information and the purchase amount information included in the missing information acquired in step S500. For instance, when the fuel type is diesel and the purchase amount is $30 according to the fueling information received in step S100, the controller of the fueling system controls the gas pump such that the gas pump supplies diesel fuel to the vehicle in the amount of $30. In another example, when the gas pump information is included in the missing information, the controller of the fueling system controls the gas pump having a gas pump number indicated in the gas pump information included in the missing information acquired in S500 to supply fuel indicated in the fuel type information in the amount indicated in the purchase amount information.

When the fueling information has been modified, the fueling system sets the gas pump according to: the fueling information received in step S100; the fueling information received in step S500; or the fuel type information and the purchase amount information included in the fueling information modified in step S600 (step S920). For example, when information other than the fuel type information and the purchase amount information is modified in step S600, the fueling system may set the gas pump to supply fuel according to the fuel type information and the purchase amount information included in the fueling information received in step S100 or according to the fuel type information and the purchase amount information included in the fueling information acquired in the step S500. When the fuel type information and the purchase amount information are modified in step S600, the fueling system may set the gas pump to supply fuel according to the fuel type information and the purchase amount information included in the fueling information modified in step S600.

Once the gas pump is set, the vehicle may be fueled.

Hereinafter, a fueling method according to a second embodiment of the present invention will be described in detail with reference to the accompanying drawings.

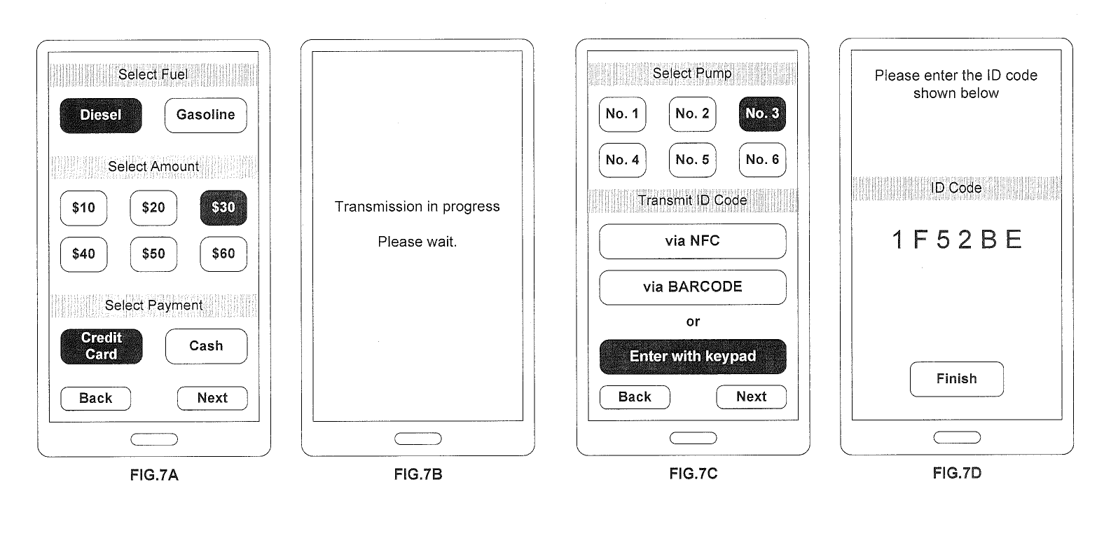

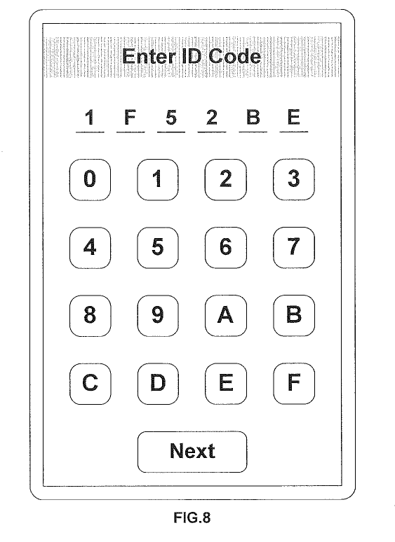

FIGS. 7A through 7D illustrates screens displayed on the mobile device used in the fueling method according to the second embodiment of the present invention is performed. A method of generating fueling information and identification code by the mobile device will be described in detail with reference to FIGS. 7A through 7D.

The process of generating and transmitting the identification code in the mobile device used in the fueling method according to the second embodiment of the present invention are shown in FIGS. 7A and 7B.

Referring to FIG. 7A, a screen for selecting the type of fuel, the amount to be purchased, and the payment method is displayed on the display of the mobile device. The user may select the fuel type corresponding to the fuel type information of the fueling information, the purchase amount corresponding to the purchase amount information of the fueling information, and the payment method corresponding to the payment information of the fueling information from the screen shown in FIG. 7A. The screen shown in FIG. 7A exemplifies that the user has selected diesel as the fuel type, $30 as the amount to be purchased and a credit card as the payment method. However, the screen may further display buttons for selecting a gas station and a gas pump number corresponding to gas pump information of fueling information. In addition, when credit card is selected as the payment method, a screen for inputting credit card number may be displayed. Further, the mobile device may display buttons for selecting the amount of fuel to be purchased in gallons (e.g. 10 gallons, 20 gallons) as the purchase amount information of the fueling information instead of the buttons for selecting the amount in dollars. The fueling information is then generated based on the selection of the user from the screen shown in FIG. 7A and then stored in the mobile device.

When the user presses “Next” button shown in FIG. 7A, the screen shown in FIG. 7B is then displayed.

Referring to FIG. 7B, the mobile device transmits the fueling information generated based on the user's selection exemplified in FIG. 7A to the server along with an identification code of the mobile device, and the server stores the fueling information and the identification code transmitted by the mobile device. Here, the server may be the server 300 shown in FIG. 2, which will be described below in detail along with the identification code.

The identification code is unique information capable of identifying the mobile device. For example, identification information stored in a SIM (subscriber identification module) card, telephone number, IP address, etc. may be used as the identification code. In addition, the identification code may be unique information capable of identifying the user of the mobile device as well as unique information capable of identifying the mobile device itself. For example, the user's credit card number, social security number, etc. may be used as the identification code. The unique information capable of identifying the mobile device itself or the user of the mobile device is stored in the mobile device as an identification code in a predetermined format and transmitted to the server along with fueling information as shown in FIG. 7B. When the identification code linked with user's credit card number, the identification code may be used for payments as well as identification of the mobile device itself and the user thereof. Moreover, when the identification code linked with the identification information stored in SIM card and the identification information is linked with the user's credit card number, the identification code may be also used for payments. That is, the identification code may be used to acquire the payment information even when the payment information is not included in the fueling information.

Transmitting the identification code and the fueling information to the server and storing the same therein facilitates fueling. Specifically, it is not necessary to select the fueling information including the fuel type, the amount, etc. every time the vehicle is fueled when the fueling information is transmitted to and stored in the server. That is, the fueling information may be retrieved from the server without entering the information necessary for fueling. For example, the mobile device may be configured to transmit the identification code to the fueling system as the mobile device is approaches a gas station instead of displaying a screen to select the fuel type, the amount, etc., and the mobile device may retrieve the fueling information corresponding to the transmitted identification code. This process will be described in detail with reference to FIGS. 7C and 7D.

FIGS. 7C and 7D schematically illustrate screens of the mobile device displaying a process of retrieving the stored fueling information by inputting the identification code according to the second embodiment of the present invention.

Referring to FIG. 7C, when the mobile device approaches the fueling zone of a certain gas station, the mobile device may display screen shown in FIG. 7C. For example, when the position information indicates that the mobile device is within the fueling zone, the mobile device displays a button to select the gas pump number and a button to select method for transmitting the identification code. At this time, the mobile device may be configured to automatically receive available gas pump number from the fueling system and display buttons corresponding to the same.

According to another example, the mobile device may be manipulated by the user to manually display the screen shown in FIG. 7C.

When the user selects the method for transmitting the gas pump number and identification code and then presses the “Next” button, the screen shown in FIG. 7D is displayed. At this time, the gas pump number may be transmitted as a part of the identification code or may be transmitted as separate data.

FIG. 7D illustrates a screen when the user selects “Enter with keypad” in the screen shown in FIG. 7C. Referring to FIG. 7D, the identification code “1F52BE” is displayed on the display of the mobile device, for example. The user may then enter the displayed identification code via the display/input device of the fueling system shown in FIG. 8. When the gas pump is equipped with the display/input device of the fueling system, the user may enter the identification code via the display/input device provided at the gas pump. When the display/input device of the fueling system is provided at the cashier counter, the user may enter the identification code via the display/input device at the cashier counter.

The controller is capable of acknowledging the gas pump which receives the identification code via the display/input device installed at the gas pump as the gas pump indicated in the gas pump information of the fueling information. Therefore, in this case, the gas pump may be determined without receiving the gas pump number from the mobile device or the server. When the identification code is received via the display/input device provided at the cashier counter, the gas pump number is additionally received or is extracted from the identification code, and the gas pump for fueling the vehicle may be set according to the received gas pump number.

The identification code is not limited to the form shown in FIGS. 7D and 8. For example, the identification code may be constructed by using only numbers (decimal code instead of hexadecimal code) or may be more than six digits. The barcode displayed when the user selects “via BARCODE” in the screen shown in FIG. 7C may be one form of the identification code. The data transmitted through the near field communication may be another form of the identification code When the “via NFC” is selected in the screen shown in FIG. 7C.

FIG. 8 illustrates an code input screen of the fueling system for inputting the identification code according to the second embodiment of the present invention.

Referring to FIG. 8, when the user enters the identification code via the display/input device of the fueling system, the fueling system receives and stores the input identification code.

When the user selects “via BARCODE” in the screen shown in FIG. 7C, a barcode representing the identification code is displayed on the display of the mobile device similar to screen shown in FIG. 4C, and the barcode may be transmitted via the barcode reader included in the communication module. For example, when the barcode reader 130b shown in FIG. 2 is provided at the gas pump, the identification code shown as the barcode may be transmitted via the barcode reader 130b at the gas pump. When the barcode reader 130b shown in FIG. 2 is provided in the cashier counter, the identification code shown as the barcode may be transmitted via the barcode reader 130b at the cashier counter.

Also, when the user selects “via NFC” in the screen shown in FIG. 7C, the mobile device may activate a near field communication module thereof to communicate with the near field communication module included in the communication module of the fueling system. For example, when the near field communication module 130a shown in FIG. 2 is provided at the gas pump, the identification code may be entered by the communication between the near field communication module of the mobile device and the near field communication module 130a provided at the gas pump. When the near field communication module 130a shown in FIG. 2 is provided at the cashier counter, the identification code may be entered by the communication between the near field communication module of the mobile device and the near field communication module 130a provided at the cashier counter.

Once the controller 110 receives the gas pump number and the identification information via the communication module, the controller 110 may set the gas pump for fueling. For example, when the identification code is received via the communication module installed at the gas pump, the gas pump at which the communication module is installed is acknowledged as the gas pump indicated in the gas pump information of the fueling information. Therefore, in this case, the gas pump can be specified without receiving the gas pump number. When the identification code is received via the communication module provided at the cashier counter, the gas pump number can be additionally received and the gas pump having the received gas pump number may be set for fueling.

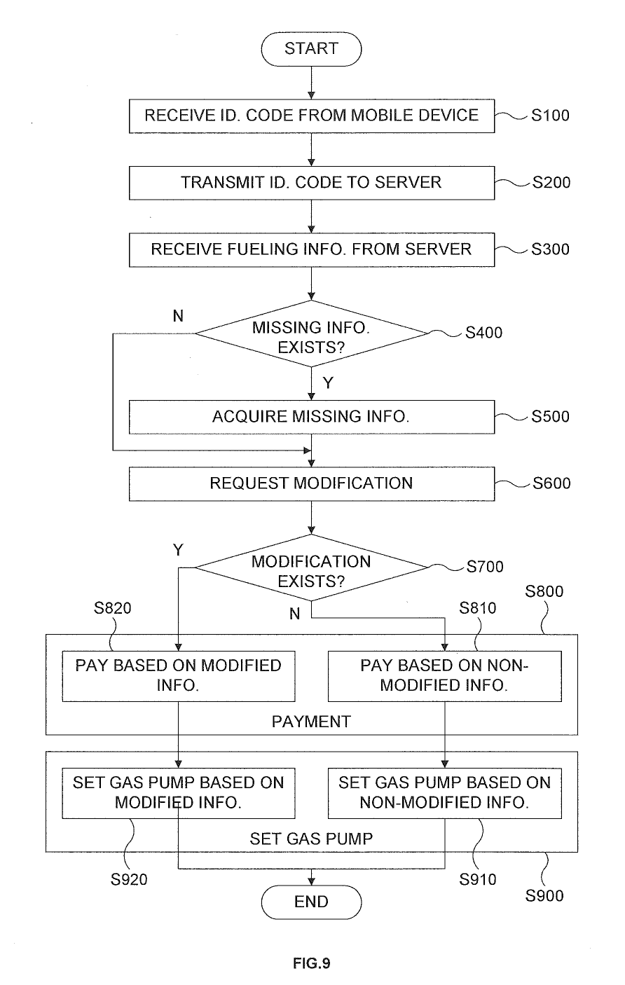

Hereinafter, the fueling method according to the second embodiment of the present invention will be described in detail with reference to FIG. 9.

FIG. 9 is a flow chart illustrating the fueling method according to the second embodiment of the present invention.

Referring to FIG. 9, the fueling system receives the identification code shown in FIG. 7D or FIG. 8 (step S100). As described above, the fueling system may be received by entering the identification code via the display/input device (140 in FIG. 2) of the fueling system. In addition, as described above, the fueling system may be configured to control the communication module 130, including the network module 130c, the near field communication module 130a, and the barcode reader 130b to receive the identification code.

Thereafter, the controller of the fueling system controls the network module 130c shown in FIG. 2 to transmit the identification code received in step S100 to the server 300 shown in FIG. 2 (step S200). The identification code may be transmitted by controlling the network module (130c in FIG. 2).

Once the identification code is received by the server, the server searches for an identification codes among the identification codes transmitted and stored in the step S200. When a matching identification code is found, the server extracts the fueling information corresponding to the matching identification code. The extracted identification information is transmitted to the fueling system.

Thereafter, the controller of the fueling system controls the network module (130c in FIG. 2) to receive the fueling information extracted and transmitted by the server (step S300).

Thereafter, the fueling system checks whether there is missing information in the received fueling information (step S400).

In order to fuel the vehicle, the user should at least select the fuel type, the purchase amount and the payment method. As described above, the fueling information includes information on the fuel type and the like. However, the fueling information may not contain all the necessary information for fueling. For example, in case the user does not select payment method on the screen shown in FIG. 7A, the received fueling information includes only the fuel type information and the purchase amount information, and the payment information is missing from the fueling information.

When there is missing information in the received fueling information (Y in step S400), the missing information is acquired (step S500).

Since the step S500 of the second embodiment is the same as that of the first embodiment described above with reference to FIG. 5, the detailed description thereof is omitted.

Thereafter, when the mobile device is in proximity of the fueling system, the fueling system requests the modification of the fueling information via the display/input device (step S600). For example, the fueling system may display a screen showing the fuel type information, the purchase amount information and the payment information included in the received fueling information on the display/input device, and inquires whether any information is to be modified. When the fueling information is modified by the user via the display/input device (Y in step S700), i.e., when the modification of the fueling information is received via the display/input device, the step S820 is performed. When the fueling information is not modified (N in step S700), the step S810 is performed. Hereinafter, steps S810 and S820 are collectively referred to as step S800.

Thereafter, the purchase amount is paid based on the payment information (step S800).

The step S800 includes a payment step S810 when the fueling information has not been modified and a payment step S820 when the fueling information has been modified. The steps S810 and S820 will be described below in detail.

First, when the fueling information has not been modified, the fueling system settles the purchase amount based on the fueling information received in step S100 or the payment information included in the missing information acquired in step S500 (step S810). For example, when the fueling information received in step S100 includes the payment information and the purchase amount information, the fueling system settles the purchase amount according to the payment information and the purchase amount information. When the payment information and/or the purchase amount information are not included in the fueling information received in step S100, the fueling system settles the purchase amount acquired in step S500, That is, the fueling system settles the purchase amount according to the payment information and the purchase amount information acquired in step S500.

When the fueling information has been modified, the fueling system settles the purchase amount based on: the payment information included the fueling information received in step S100; the payment information included the fueling information received in step S100 and modified in the step S600; the payment information included in the missing information acquired in step S500; or the payment information included in the missing information acquired in step S500 and modified in the step S600 (step S820). For example, when information other than the payment information and the purchase amount information is modified in step S600, the fueling system may settle (charge) the purchase amount based on the payment information included in the fueling information received in step S100 or the payment information included in the missing information acquired in step S500. In another example, when at least one of the payment information and the purchase amount information is modified in step S600, the fueling system may settle the modified purchase amount and/or the purchase amount information.

Since the steps S810 and S820 according to the second embodiment are the same as those of the first embodiment shown in FIG. 6, the detailed description thereof is omitted.

Thereafter, when the payment is complete, the gas pump is set (step S900).

The step S900 includes a gas pump setting step S910 when the fueling information has not been modified and a gas pump setting step S920 when the fueling information has been modified. The steps S910 and S920 will be described below in detail.

When the fueling information has not been modified, the controller of the fueling system sets the gas pump according to the fuel type information and the purchase amount information included in the fueling information received in step S100 (step S910). In one example, when the fuel type information and/or amount information are included in the missing information acquired in step S500, the controller of the fueling system sets the gas pump according to the fuel type information and the purchase amount information included in the missing information acquired in step S500. For instance, when the fuel type is diesel and the purchase amount is $30 according to the fueling information received in step S100, the controller of the fueling system controls the gas pump such that the gas pump supplies diesel fuel to the vehicle in the amount of $30. In another example, when the gas pump information is included in the missing information, the controller of the fueling system controls the gas pump having a gas pump number indicated in the gas pump information included in the missing information acquired in S500 to supply fuel indicated in the fuel type information in the amount indicated in the purchase amount information.

When the fueling information has been modified, the fueling system sets the gas pump according to: the fueling information received in step S100; the fueling information received in step S500; or the fuel type information and the purchase amount information included in the fueling information modified in step S600 (step S920). For example, when information other than the fuel type information and the purchase amount information is modified in step S600, the fueling system may set the gas pump to supply fuel according to the fuel type information and the purchase amount information included in the fueling information received in step S100 or according to the fuel type information and the purchase amount information included in the fueling information acquired in the step S500. When the fuel type information and the purchase amount information are modified in step S600, the fueling system may set the gas pump to supply fuel according to the fuel type information and the purchase amount information included in the fueling information modified in step S600.

Once the gas pump is set, the vehicle may be fueled.

The fueling method according to the present invention has the following advantages.

(a) Mis-fueling may be prevented by presetting the fuel type and the purchase amount.

(b) Time may be saved by presetting the fuel type, the purchase amount and the payment.

(c) In particular, when the fueling method according to the present invention is employed in a self-service gas station, the vehicle may be fueled with convenience.

(d) Since the fueling information is stored in the server and retrieved when fueling, it is not necessary to enter the fueling information more than once.

(e) Since unique identification code is used, the gas pump may be selected at cashier counter as well as at the gas pump.

What is claimed is:

1. A fueling method performed in a fueling system comprising: a communication module in communication with a mobile device; a gas pump supplying a fuel to a vehicle; a display/input device receiving user input and displaying a screen; and a controller controlling the communication module and the gas pump, the method comprising:
(a) receiving fueling information containing at least one of fuel type information, purchase amount information, payment information and gas pump information from mobile device by controlling the communication module;
(b) acquiring missing information missing from the fueling information when one or more of the fuel type information, the purchase amount information, the payment information and the gas pump information is missing from the fueling information;
(c) making a payment according to the payment information included in the fueling information received in (a) or the payment information included in the missing information acquired in (b); and
(d) setting the gas pump for fueling based on the fueling information received in (a) or the missing information acquired in (b).

2. The fueling method of claim 1, further comprising: (e) requesting a modification of the fueling information via the display/input device when the mobile device approaches the fueling system.

3. The fueling method of claim 2, wherein (d) comprises: setting the gas pump for fueling based on the fueling information modified in (e) when the modification of the fueling information is received via the display/input device.

4. The fueling method of claim 1, wherein the communication module comprises a near field communication module, and (a) comprises: receiving the fueling information from the mobile device by controlling the near field communication module.

5. The fueling method of claim 1, wherein the communication module comprises a barcode reader, and (a) comprises: receiving the fueling information in barcode or QR code from the mobile device by controlling the barcode reader.

6. The fueling method of claim 1, further comprising: (f) receiving at least one of coupon information and mileage information by controlling the communication module.

7. The fueling method of claim 6, wherein the communication module comprises a near field communication module, and (f) comprises: receiving at least one of the coupon information and the mileage information from the mobile device by controlling near field communication module.

8. The fueling method of claim 1, wherein the communication module comprises a network module, and (a) comprises: receiving the fueling information from the mobile device by controlling the network module.

9. The fueling method of claim 8, wherein the communication module further comprises a near field communication module, further comprising: receiving at least one of coupon information and mileage information from the mobile device by controlling near field communication module.

10. The fueling method of claim 1, wherein (b) comprises: (b-1) requesting the missing information when the missing information exists in the fueling information; and (b-2) receiving the missing information via the display/input device.

11. The fueling method of claim 1, further comprising: (h) receiving identification code of the mobile device by controlling the communication module.

12. The fueling method of claim 11, wherein (b) comprises: acquiring the payment information from the identification code received in (h) when the payment information is missing from the fueling information.

13. The fueling method of claim 12, wherein (c) comprises: (c-1) authenticating the payment information acquired in (b); and making a payment when the payment information is authenticated in (c-1).

14. The fueling method of claim 13, wherein (c-1) comprises authenticating the payment information by at least one of fingerprint, password and iris recognition.

15. The fueling method of claim 1, further comprising: (i) acknowledging the mobile device via the communication module when the mobile device approaches the fueling system.

16. The fueling method of claim 15, wherein (i) comprises acknowledging the mobile device based on position information transmitted from the mobile device and received via the communication module when the mobile device approaches the fueling system.
